(19) United States
(12) Patent Application Publication
(10) Pub. No.: US 2011/0274094 A1
(43) Pub. Date: Nov. 10, 2011

(54) METHODS AND APPARATUS FOR ESTIMATING A GEOLOCATION OF A WIRELESS COMMUNICATIONS DEVICE

(75) Inventors: Aleksandar Jovicic, Jersey City, NJ (US); Thomas Richardson, South Orange, NJ (US); Cyril Measson, Somerville, NJ (US)

(73) Assignee: QUALCOMM Incorporated, San Diego, CA (US)

(21) Appl. No.: 12/774,938

(22) Filed: May 6, 2010

(51) Int. Cl. H04W 40/00

(52) U.S. Cl. 370/338

(57) ABSTRACT

The methods and apparatus described herein are used to perform indoor and urban geolocation positioning. One method of estimating a geolocation of one of a first wireless device or a second wireless device includes receiving, at the first wireless device, a signal from the second wireless device, determining, at the first wireless device, a physical characteristic of the received signal, and determining, at the first wireless device, a region on a map representing a geolocation of the first wireless device or the second wireless device based on the physical characteristic of the received signal, a state transition matrix and a state occupancy vector.

### BACKGROUND

1. Field

The invention relates to wireless communications. More particularly, the invention relates to methods and apparatus for estimating a geolocation of a wireless communications device.

2. Background

Wireless communications continues to grow in demand and has become an integral part of both personal and business communications. Wireless communications allow users to transmit, receive, access or exchange data from most anywhere using wireless networks and wireless communications devices such as laptops, cellular devices, smart phones, iPhones®, BlackBerrys®, etc.

The Institute of Electrical and Electronic Engineers (IEEE) has developed standards (e.g., the 802.11 standard) for wireless communications between wireless communications devices. Wireless communications can take place in a localized area such as a building, an area within a building, an area having several buildings, outdoor areas or a combination of indoor and outdoor areas. One long-standing unresolved problem with wireless communications is the difficulty in obtaining accurate geolocation positioning of a wireless communications device in indoor and dense urban areas.

Some existing position detection and motion tracking technologies have been developed that rely on the transmission and reception of radio-frequency (RF) signals. These technologies include (1) global positioning systems (GPS), (2) wide area network (WAN), and (3) wireless fidelity (WiFi). GPS technology works well when the receiver has a direct line-of-sight with the satellites. On the other hand, GPS does not work very well inside a building or a parking structure. WAN technology incorporates timing-based triangulation or power-based methods that also work well in line-of-sight situations but are otherwise inaccurate and can only be used to augment the timing information. WiFi technology utilizes received signal strength indication (RSSI) based methods for positioning determination but these methods are inaccurate for indoor positioning determination of the wireless communications device. Hence, these technologies work well in outdoor areas where there are few obstructions between the transmitter and the receiver; however, these technologies have several drawbacks when the wireless communications device is indoors or in dense urban areas.

Therefore, it has been recognized by those skilled in the art that a need exists for methods and apparatus for estimating a geolocation of a wireless communications device in indoor and dense urban areas.

### SUMMARY

The methods and apparatus described herein are used to perform indoor and urban geolocation positioning. One method of estimating a geolocation of one of a first wireless device or a second wireless device includes receiving, at the first wireless device, a signal from the second wireless device, determining, at the first wireless device, a physical characteristic of the received signal, and determining, at the first wireless device, a region on a map representing a geolocation of the first wireless device or the second wireless device based on the physical characteristic of the received signal, a state transition matrix and a state occupancy vector.

The wireless communications device or the wireless network device may adjust the state occupancy vector for at least one state based on a pre-determined function of the physical characteristic of the received signal. The pre-determined function is based on a physical characteristic prediction map which describes a predicted probability distribution, as a function of the geographic position of a receiver (e.g., the first wireless device) of the physical characteristic of the received signal transmitted by the second wireless device.

The pre-determined function may be a probability density function. The probability density function can be an exponential distribution with a mean value provided by the predicted signal power at that location. The state occupancy metrics can be updated based on the probability density function. For example, given the measured physical characteristics of the received signal, the state occupancy metrics are the largest for those states for which the probability density function, evaluated at the measured physical characteristic value, yields the largest value.

An apparatus for estimating a geolocation, the apparatus including a first wireless device configured to receive a signal from a second wireless device, determine a physical characteristic of the received signal, and determine a region on a map representing a geolocation of the first wireless device or the second wireless device based on the physical characteristic of the received signal, a state transition matrix and a state occupancy vector.

### BRIEF DESCRIPTION OF THE DRAWINGS

The features, objects, and advantages of the invention will become more apparent from the detailed description set forth below when taken in conjunction with the drawings, wherein:

FIG. 1 is a simplified block diagram of a network (also can be referred to as a system) having a base station, a server, first and second wireless network devices, and a wireless communications device in accordance with various embodiments.

FIG. 2 is a block diagram of an exemplary wireless communications device in accordance with various embodiments.

FIG. 3A is a physical layout map of the geographic area showing a floor plan of a building in accordance with various embodiments.

FIG. 3B is an exploded view of a portion of the geographic area shown in FIG. 3A to illustrate a set of regions in the geographic area in accordance with various embodiments.

FIG. 4 is a flow chart illustrating a method of estimating a geolocation of a wireless communications device in accordance with various embodiments.

FIG. 5 is a block diagram illustrating exemplary components for the apparatus and the means for apparatus for estimating a geolocation of a wireless communications device in accordance with various embodiments.

### DETAILED DESCRIPTION

Methods, apparatus, and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

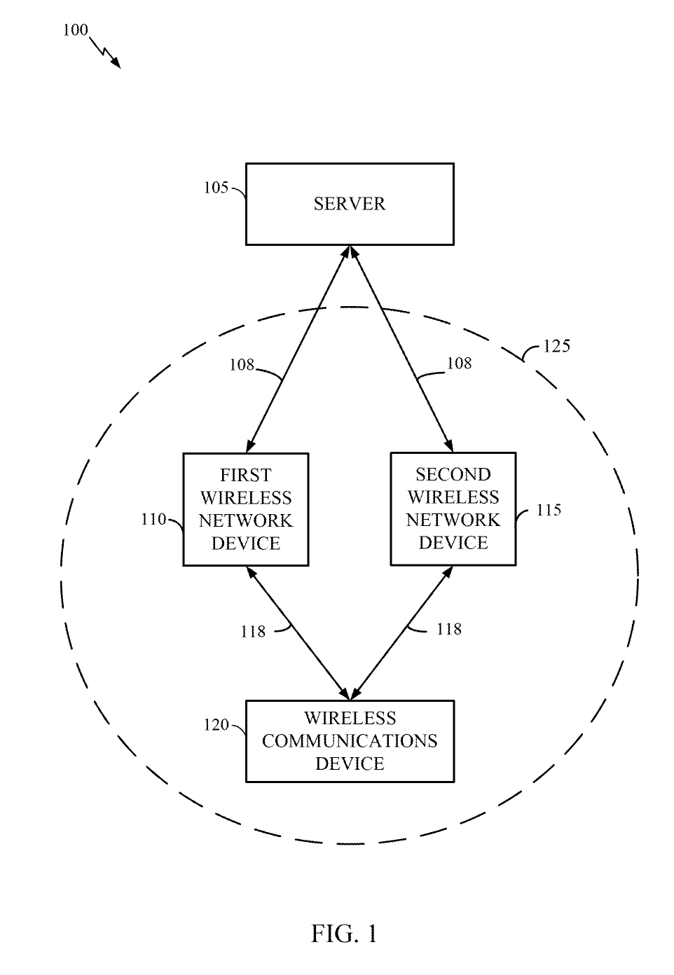

FIG. 1 is a simplified block diagram of a network 100 (also can be referred to as a system 100) having a server 105, first and second wireless network devices 110 and 115, and a wireless communications device 120 in accordance with various embodiments. The network 100 is configured to estimate a geolocation of the wireless communications device 120. In a device-centric configuration, the wireless communications device 120 executes the algorithms, computations, and methods described herein. In a network-centric configuration, the server 105 and/or one or more wireless network devices 110 and 115 execute the algorithms, computations, and methods described herein. Also, in several embodiments, various combinations of the server 105, the first and second wireless network devices 110 and 115, and/or the wireless communications device 120 can perform one or more functions, steps or tasks of the algorithms, computations, and methods described herein. The algorithms, computations, and methods described herein can be implemented using hardware, software, and combinations thereof.

As an example, the network 100 is configured to estimate or determine the relative location of the wireless communications device 120 and estimate or track the movement of the wireless communications device 120. Hence, the network 100 performs real-time position detection and motion tracking of the wireless communications device 120. In one embodiment, the relative location of the wireless communications device 120 can be estimated using indoor radio frequency (RF) models. The wireless communications device 120 can be stationary or moving outdoors, indoors and through dense urban areas. In one embodiment, the wireless communications device 120 can be moving at a maximum velocity of up to about 5 meters per second.

In various embodiments, the network 100 can include one or more networks such as a local area network (LAN), a wireless local area network (WLAN), a wireless fidelity (WiFi) network, an unlicensed network (i.e., a network operating in the unlicensed spectrum), a licensed network (i.e., a network operating in the licensed spectrum) and/or a carrier sense multiple access with collision avoidance (CSMA/CA) network. The server 105 can be an application server and/or a network server. As an example, the server 105 can include a processor, a microprocessor, a controller, a wireless receiver, a wireless transmitter, a cellular antenna, a WiFi antenna, a database, and/or a memory. The server 105 provides application, data and network functionality and data traffic flow to and from the base station 101, the wireless network devices 110 and 115 and/or the wireless communications device 120.

The network 100 can include one or more wireless network devices 110 and 115. Each wireless network device can be one of a mobile wireless communications device, a wireless network device, a wireless local area network access point, a wide area network base-station or a dedicated wireless positioning device. Each wireless network device can include one or more access points (APs). The APs are communication ports for the wireless communications device 120 such that the wireless communications occurs across an air link between the APs and the wireless communications device 120. The APs receive data from the server 105 and transmit the data to the wireless communications device 120. The APs can also receive data from the wireless communications device 120 and transmit the data to the server 105. Each wireless network device may be a dedicated or multi-purpose AP operating in the licensed spectrum and/or the unlicensed spectrum such as WiFi hotspots.

The wireless communications device 120 can be a mobile wireless communications device, a wireless network device, a wireless local area network access point, a wide area network base-station, a dedicated wireless positioning device, a node, a wireless node, a network node, a WiFi device, a mobile device, a personal digital assistant (PDA), a smart phone or a portable communications device configured to operate in the licensed spectrum and/or the unlicensed spectrum, or a white-space device (WSD) configured to operate in the licensed spectrum and/or the unlicensed spectrum. A WSD can be a mobile device, a laptop computer or other portable device operating in open or unused frequencies. Even though one server 105, two wireless network devices 110 and 115, and one wireless communications device 120 are shown in FIG. 1, the network 100 can include one or more servers 105, one or more wireless network devices 110 and/or 115, one or more wireless communications devices 120, and combinations thereof.

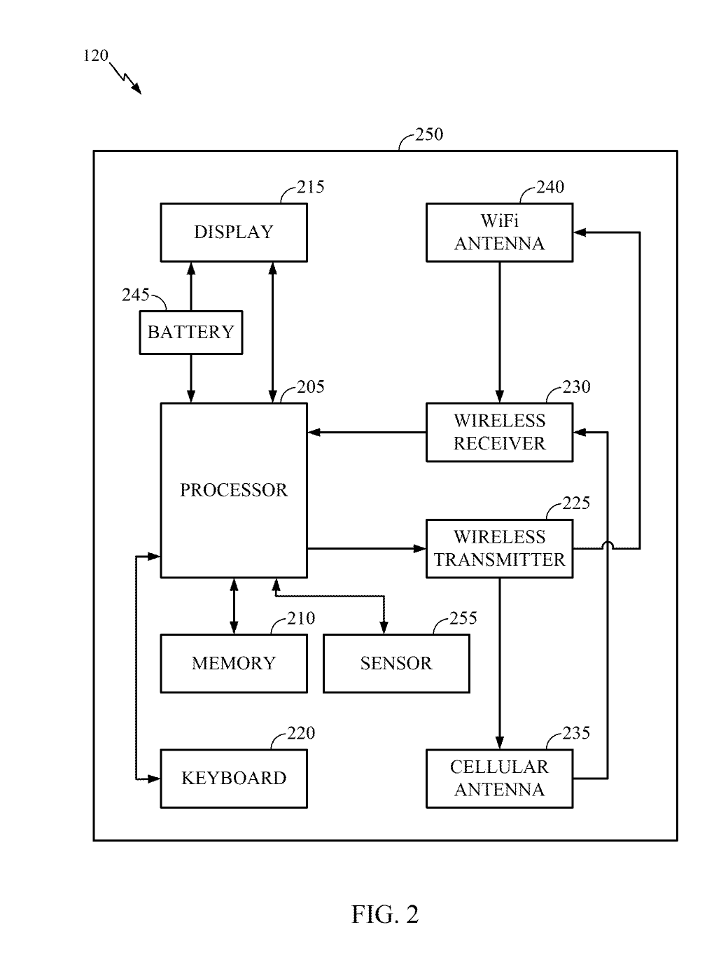

FIG. 2 is a block diagram of an exemplary wireless communications device 120 in accordance with various embodiments. The wireless communications device 120 is configured to receive and transmit signals and data in or using the licensed spectrum and/or the unlicensed spectrum. The wireless communications device 120 may include a processor 205, a memory 210, a display or a touch screen 215, a keyboard 220, a wireless transmitter 225, a wireless receiver 230, a first antenna 235, a second antenna 240, a power source 245 (e.g., a battery), and a sensor 255. The chips, components or modules may be attached or formed on a printed circuit board 250. The printed circuit board 250 can refer to any dielectric substrate, ceramic substrate, or other circuit carrying structure for carrying signal circuits and electronic components within the wireless communications device 120.

The processor 205 may be implemented using hardware, software, firmware, middleware, microcode, or any combination thereof. The processor 205 may be an Advanced RISC Machine (ARM), a controller, a digital signal processor (DSP), a microprocessor, an encoder, a decoder, circuitry, a processor chip, or any other device capable of processing data, and combinations thereof. The term “circuitry” may include processor circuitry, memory circuitry, RF transceiver circuitry, power circuitry, video circuitry, audio circuitry, keyboard circuitry, and display circuitry.

The memory 210 may include or store various routines and data. The term “memory” and “machine readable medium” include, but are not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data. The machine readable instructions may be stored in the memory 210 and may be executed by the processor 205 to cause the processor 205 to perform various functions as described in this disclosure. The display 215 may be a LCD, LED, plasma display screen or a touch screen and the keyboard 220 may be a standard keyboard (e.g., a QWERTY layout) having letters and numbers. The keyboard 220 may be implemented on or using the touch screen.

The wireless transmitter 225 is coupled to the processor 205 and is used to encode and format the data for transmission via the first antenna 235 and/or the second antenna 240. The wireless transmitter 225 includes chips, circuitry and/or software that are used to transmit the data and/or signals that are received from the processor 205 to the first antenna 235 and/or the second antenna 240 for transmission over one or more channels.

The wireless receiver 230 is coupled to the processor 205 and is used to decode and parse the data after being received from the first antenna 235 and/or the second antenna 240. The wireless receiver 230 includes chips, circuitry and/or software that are used to receive the data and/or signals from the first antenna 235 and/or the second antenna 240. The data and/or signals are sent to the processor 205 for calculation and/or use by the processor 205.

The first antenna 235 may be positioned at a lower right portion of the wireless communications device 120 and the second antenna 240 may be positioned at an upper right portion of the wireless communications device 120. The first antenna 235 may be a cellular antenna, a GSM antenna, a CDMA antenna, a WCDMA antenna, or any other antenna capable of operating using the licensed spectrum. The second antenna 240 may be a WiFi antenna, a GPS antenna, or any other antenna capable of operating using the unlicensed spectrum. The power source 245 supplies power to the components or modules shown in FIG. 2.

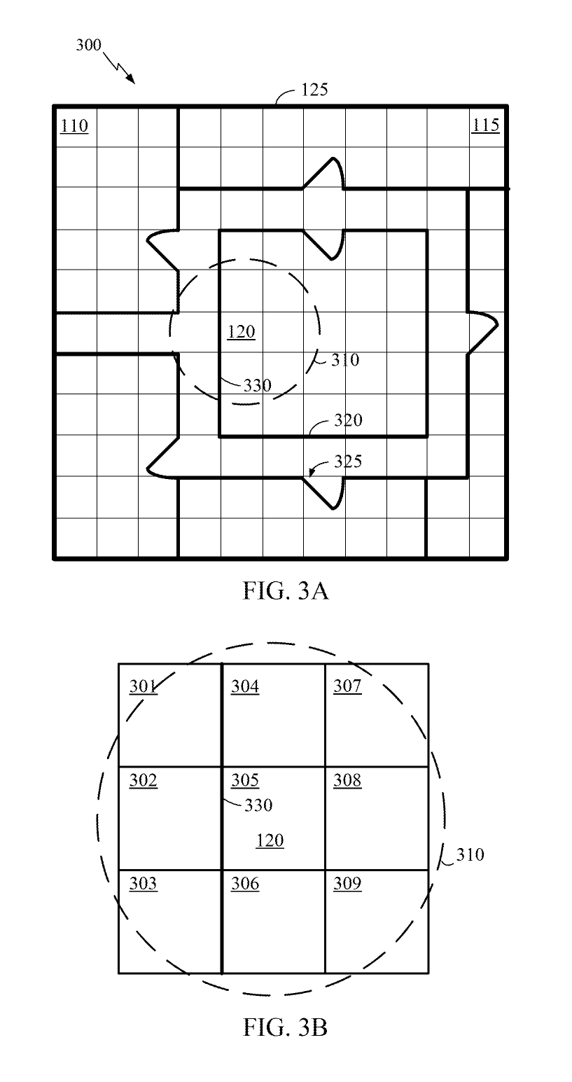

FIG. 3A is a physical layout map 300 of the geographic area 125 showing a floor plan of a building in accordance with various embodiments. For illustrative purposes, the geographic area 125 is shown as a floor plan of a building; however, the geographic area 125 can be any outdoor area, indoor area or dense urban area. The geographic area 125 can be divided into a set of predetermined regions as shown by squares. Each region can be defined to be one or more squares. Each region does not have to be square in shape but has been shown as a square for illustrative purposes. Each region corresponds to a state.

Each region in the set of regions corresponds to a state in a set of states. Each region can be assigned to a different, unique state. Therefore, each state represents at least one region. Alternatively, the wireless communications device 120 can combine several of the regions and assigns these combined regions to one state. For example, all the regions 301-309 can be assigned to one state. Hence, several regions can be mapped or assigned to a single state. Each state may also include additional information other than the region. Each region may be non-overlapping or overlapping with respect to another region as shown on the map 300.

FIG. 3B is an exploded view of a portion 310 of the geographic area 125 shown in FIG. 3A to illustrate a set of regions 301-309 in the geographic area 125 in accordance with various embodiments. In this example, each square is defined to be a region that is approximately 1 meter×1 meter. Alternatively, each region can be more than one square or other non-square portion of the geographic area 125. Each region can also be a 3-dimensional space encompassing a defined volume of space.

The map 300 shows a physical layout of the geographic area 125 displaying any major signal obstructions or physical constraints such as barriers, walls, buildings, ceilings, doors, floors, furniture, office objects, home objects, shopping mall objects, and combinations thereof. For example, the map 300 shows walls 320 and 330 and shows door 325. The map 300 contains information about the location of each of the physical constraints. The map 300 may be created using the server 105 and downloaded onto the wireless network device 110 or the wireless communications device 120. In one embodiment, the map 300 may be created using the wireless communications device 120. The map 300 represents a geographic area in which the server 105, the wireless network devices 110 and 115, and/or the wireless communications device 120 may be located.

In the device-centric configuration, the first wireless device (i.e., the wireless communications device 120) may determine information about the location of the second wireless device (i.e., the wireless network device 110 or 115) from the map 300. That is, the information about the location of the second wireless device on the map 300 is known to the first wireless device from information contained in the map 300. Alternatively, the information about the location of the second wireless device may be received by the first wireless device from a signal transmitted by one of the second wireless device, a mobile wireless communications device, a wireless network device, a wireless local area network access point, a wide area network base-station, a dedicated wireless positioning device or a wired network.

In the network-centric configuration, the first wireless device (i.e., the wireless network device 110 or 115) may determine information about its own location from the map 300. Alternatively, the information about its location may be determined by the first wireless device from a signal transmitted by one of a mobile wireless communications device, a wireless network device, a wireless local area network access point, a wide area network base-station, a dedicated wireless positioning device or a wired network.

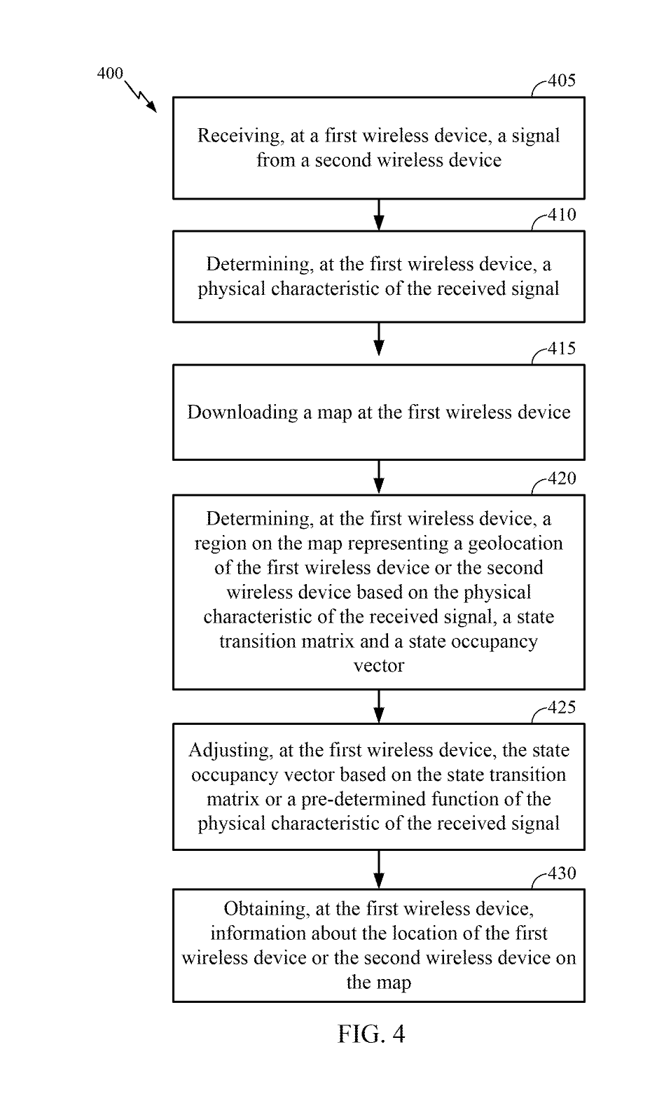

In the device-centric configuration, the physical layout map 300 may be pre-loaded and stored onto the memory 210 of the wireless communications device 120 or downloaded on-demand from the WAN/WiFi network 100 onto the memory 210 of the wireless communications device 120 (see also 415 in FIG. 4). In the network-centric configuration, the physical layout map 300 is stored on the server 105 or on the wireless network device(s) 110 and/or 115 without pre-loading or storage onto the wireless communications device 120. Hence, the algorithms are executed by the server 105 and/or the wireless network device(s) 110 and/or 115. The first wireless device may be the server 105, the wireless network device 110 or 115, or the wireless communications device 120.

A physical characteristic prediction map may be created by the server 105, the wireless network device(s) 110 and/or 115, and/or the wireless communications device 120. The prediction map may be pre-loaded and stored onto the server 105 or the memory 210 or downloaded on-demand from the WAN/WiFi network 100 onto the memory 210 of the wireless communications device 120. The prediction map may include data of the received RF power (or signal strength) and/or the delay spread from a plurality of transmitters (e.g., the first and second wireless network devices 110 and 115) whose location and transmit powers are known. The plurality of transmitters are generally located within the geographic area 125 as shown in FIG. 1. The prediction map of RF signal strength and/or delay spread measurements can be created offline by numerous measurements across the entire geographic area 125. In one embodiment, an initial set of measurements for the prediction map can be interpolated using ray-tracing software to predict the RF signal strength and/or the delay spread measurements (i.e., values) across the entire geographic area 125. In another embodiment, the prediction map can be created using a bootstrapping method in which several wireless communications devices that have established their positions or locations by some method (e.g., a user-assisted location determination) can upload RF signal strength and/or delay spread measurements at these known locations. In this embodiment, the greater the number of wireless communications devices participating in the bootstrapping method, the better the accuracy for other wireless communications devices in the future.

The wireless communications device 120 performs RF signal strength and/or delay spread measurements at periodic time intervals (e.g., every 1 second) to update the prediction map stored in its memory 210 as the wireless communications device 120 moves through the geographic area 125. In the network-centric configuration, the prediction map is stored on the server 105 or on the wireless network device(s) 110 and/or 115 without pre-loading or storage onto the wireless communications device 120. Hence, the algorithms are executed by the server 105 and/or the wireless network device(s) 110 and/or 115.

FIG. 4 is a flow chart illustrating a method 400 of estimating a geolocation of a wireless device in accordance with various embodiments. For illustrative purposes, the first wireless device is the wireless communications device 120 and the second wireless device is the wireless network device 110. However, the first and second wireless device can be interchanged or other devices can be used as the first and second wireless devices.

Referring to FIGS. 1, 2, 3A, 3B, and 4, the wireless communications device 120 (e.g., the wireless receiver 230 and/or the processor 205) receives one or more signals 118 from the wireless network device(s) 110 and/or 115 whose position is known to the wireless communications device 120 (see also 405 in FIG. 4). The signal 118 may be a broadcast signal such as a beacon signal that is sent from the wireless network device(s) 110 and/or 115 to multiple wireless communications devices. The signal 118 may be one of a sequence of positioning signals transmitted by the wireless network devices 110 and/or 115. For example, the signal 118 from the wireless network devices 110 and/or 115 may be one or more of a peer-to-peer discovery signal, a peer-to-peer traffic signal, a peer-to-peer paging signal, a dedicated positioning signal or a beacon signal.

After receiving the signal 118, the wireless communications device 120 (e.g., the processor 205) determines a physical characteristic of the signal 118 (see also 410 in FIG. 4). The physical characteristic of the received signal 118 can be received average power, received peak power, received average energy, received peak energy, tap delay, tap delay spread, and/or combinations thereof. The wireless communications device 120 may perform RF signal strength and/or delay spread measurements at periodic intervals as the user carrying the wireless communications device 120 moves through indoor areas and/or dense urban areas. Given the sequence of past positioning measurements and using the information from the maps of obstructions and powers, the processor 205 computes the most likely current location of the wireless communications device 120 (see also 430 in FIG. 4).

In one embodiment, the wireless communications device 120 receives round-trip time-of-arrival (RT-TOA) measurements of signals transmitted by the wireless network devices 110 and 115 whose locations are known to the wireless communications device 120. For example, if the processor 205 determines that the wireless communications device 120 has a direct, unobstructed line-of-sight path to one or more wireless network devices based on, for example, the initial positioning signals 118, the RT-TOA measurements can be used to further increase the accuracy of the estimate of the location of the wireless communications device 120. If the two or more wireless network devices 110 and 115 are synchronized, the wireless communications device 120 can perform time-difference-of-arrival (TDOA) triangulation measurements to further increase the accuracy of the estimate of the location of the wireless communications device 120.

In the device-centric configuration, the first wireless device (i.e., the wireless communications device 120, e.g., the processor 205) determines a region (e.g., 305) on the map 300 representing a geolocation of its own position based on the physical characteristic(s) of the received signal 118, a state transition matrix, and a state occupancy vector transmitted by the second wireless device (i.e., the wireless network device 110 or 115) (see also 420 in FIG. 4). In the network-centric configuration, the first wireless device (i.e., the wireless network device 110 or 115) determines a region (e.g., 305) on the map 300 representing a geolocation of the second wireless device (i.e., the wireless communications device 120) based on the physical characteristic(s) of the received signal 118, a state transition matrix, and a state occupancy vector (see also 420 in FIG. 4). In one embodiment, the region is determined by selecting a state with the highest state occupancy metric.

In the device-centric configuration, the geographic area 125 includes a set of locations or regions (e.g., 301-309) around the second wireless device which contains at least some locations where the signal(s) 118 transmitted by the second wireless device is detectable by the first wireless device. In the network-centric configuration, the geographic area 125 includes a set of locations or regions (e.g., 301-309) around the first wireless device which contains at least some locations from which the signal(s) 118 transmitted by the second wireless device is detectable by the first wireless device. In both the device-centric and the network-centric configurations, the second wireless device is the device that transmits the signal(s) 118 and the first wireless device is the device that detects or receives the signal(s) 118.

The geographic area 125 can be divided into a number of regions (as shown by each square). Each region (e.g., 301) is defined by an area (e.g., 1 meter×1 meter) or space on the map 300. In one embodiment, the area or size of each region in the set of regions is monotonically decreasing with the rate at which the second wireless device transmits the sequence of signals 118.

In the device-centric configuration, the first wireless device may create the state transition matrix or receive the state transition matrix from the second wireless device. In the network-centric configuration, the first wireless device may create the state transition matrix or receive the state transition matrix from the server 105. The state transition matrix is an N×N matrix representing, in one embodiment, the probability of the wireless communications device 120 moving from one state (e.g., at least one unique region) to another state (e.g., at least another unique region). The state transition matrix includes state transition metrics that correspond to pairs of states and which can be a number, a value, a vector, a probability between 0 and 1, and combinations thereof. In one embodiment, the two states in a pair of states may correspond to regions that are adjacent to one another. The states in a pair of states do not have to correspond to regions that are adjacent to one another. For example, if the wireless communications device 120 is moving rapidly (e.g., a user of the wireless communications device 120 may be running inside a building or a car carrying the wireless communications device 120 may be moving through a parking garage), the pair of states may not be adjacent to each other. Even though a pair of states may represent regions that are far apart from one another, the wireless communications device 120 may still create or receive a state transition metric for the pair of states; however, the state transition metric for these pair of states will be 0 indicating that the probability of the wireless communications device 120 being able to move from the first unique region of the pair to the second unique region of the pair is 0. Alternatively, in one embodiment, a pair of unique regions that are far apart from one another may not be assigned to a state transition metric.

The state transition matrix is based on a mobility model. The mobility model is based on a probability distribution on a distance and a direction that the wireless communications device 120 can move in a time interval determined by a rate at which the second wireless device transmits the sequence of signals 118. The rate is determined by the number of signals 118 transmitted in one second, for example.

In one embodiment, the state transition matrix may be based on a set of physical constraints on the map 300. The set of physical constraints can include, for example, barriers, walls, buildings, ceilings, doors, floors, furniture, office objects, home objects, shopping mall objects, and combinations thereof. The state transition matrix may be created using information about the set of physical constraints as well as prior information about the anticipated velocity of the wireless communications device 120. The prior information can be a velocity model obtained from past measurements, accelerometer readings from the sensor 255 on the wireless communications device 120, and/or a maximum velocity assumption. In the device-centric configuration, the state transition matrix may be pre-loaded and stored onto the memory 210 or downloaded on-demand from the WAN/WiFi network 100 onto the memory 210 of the wireless communications device 120.

The state occupancy vector includes N state occupancy metrics that correspond to states and which can be a number, a value, a vector, a probability between 0 and 1, and combinations thereof. Each state occupancy metric corresponding to a state represents, in one embodiment, the probability that the wireless communications device 120 is located in the region represented by the state.

In the device-centric configuration, the wireless communications device 120 may determine an initial state occupancy metric for at least one state in the set of states. In the network-centric configuration, the wireless network device 110 may determine an initial state occupancy metric for at least one state in the set of states. Using FIG. 3B as an example, if each region is assigned to a different state, the wireless communications device 120 or the wireless network device 110 will assign an initial state occupancy metric of 1/9 to each region. Hence, the probability of the wireless communications device 120 being in any of these 9 states is initially 1/9. The total should add up to 1. The state with the highest or largest state occupancy metric (i.e., largest probability) is the state that determines or indicates the current position of the wireless communications device 120.

After the initial state occupancy metric has been assigned to each state in the set of states, the wireless communications device 120 or the wireless network device 110 can adjust the state occupancy vector for at least one state based on the state transition matrix for at least one of the pair of states (see also 425 in FIG. 4). The state occupancy vector can be updated based on the physical characteristics of the signal 118 (e.g., the RF signal strength and/or the delay spread measurements) and/or the state transition metrics. For example, if the state transition metrics indicate that a physical constraint (e.g., wall 330) exists between the pairs of regions 301, 302, 303, and 304, 305, 306, respectively, as shown in FIG. 3B, the state transition metrics for states corresponding to the regions 301, 302 and 303 will be adjusted to 0 to indicate that the wireless communications device 120 cannot move from any one of the regions 304, 305 or 306 to any one of the regions 301, 302 or 303. Since these 3 state transition metrics are 0, the remaining state transition metrics may be adjusted to ⅙, thus increasing the probability that the wireless communications device 120 is located in one of the regions 304, 305, 306, 307, 308 or 309.

The wireless communications device 120 or the wireless network device 110 may adjust the state occupancy vector for at least one state based on a pre-determined function of the physical characteristic of the received signal 118 (see also 425 in FIG. 4). The pre-determined function is based on the physical characteristic prediction map which describes a predicted probability distribution, as a function of the geographic position of a receiver (e.g., the first wireless device) of the physical characteristic of the received signal 118 transmitted by the second wireless device (e.g., the wireless network device(s) 110 and/or 115).

The pre-determined function may be a probability density function. The probability density function can be an exponential distribution with a mean value provided by the predicted signal power at that location. The state occupancy metrics can be updated based on the probability density function. For example, given the measured physical characteristics of the received signal 118, the state occupancy metrics are the largest for those states for which the probability density function, evaluated at the measured physical characteristic value, yields the largest value.

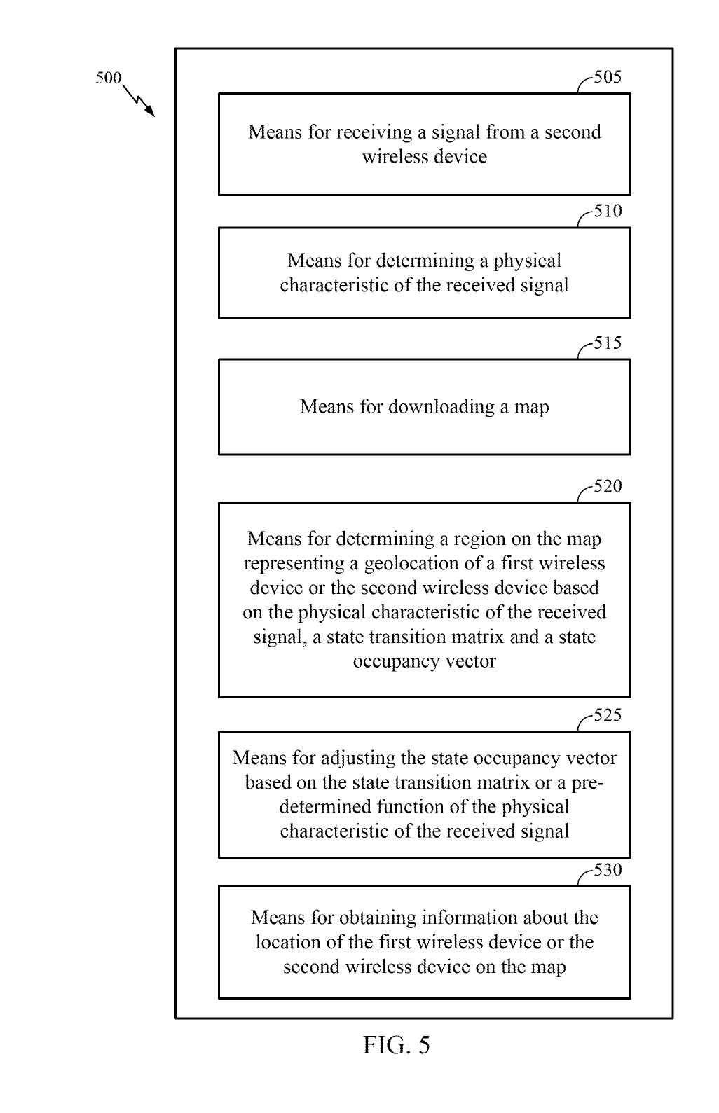

FIG. 5 is a block diagram illustrating exemplary components for the apparatus and the means for apparatus for estimating a geolocation of the wireless communications device 120 in accordance with various embodiments. The apparatus 500 may include a module 505 for receiving, at a first wireless device, a signal 118 from a second wireless device, a module 510 for determining, at the first wireless device, a physical characteristic of the received signal 118, and a module 515 for downloading a map onto the first wireless device.

The apparatus 500 may also include a module 520 for determining, at the first wireless device, a region on the map 300 representing a geolocation of the first wireless device or the second wireless device based on the physical characteristic of the received signal, a state transition matrix, and a state occupancy vector, a module 525 for adjusting, at the first wireless device, the state occupancy vector based on the state transition matrix or a pre-determined function of the physical characteristic of the received signal 118, and a module 530 for obtaining, at the first wireless device, information about the location of the first wireless device or the second wireless device on the map.

Those skilled in the art will appreciate that the various illustrative logical blocks, modules, circuits, and algorithms described in connection with the embodiments disclosed herein may be implemented as electronic hardware, computer software, or combinations of both. To illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein. A general purpose processing device may be a microprocessing device, but in the alternative, the processing device may be any conventional processing device, processing device, microprocessing device, or state machine. A processing device may also be implemented as a combination of computing devices, e.g., a combination of a DSP and a microprocessing device, a plurality of microprocessing devices, one or more microprocessing devices in conjunction with a DSP core or any other such configuration.

The apparatus, methods or algorithms described in connection with the embodiments disclosed herein may be embodied directly in hardware, software, or combination thereof. In software the methods or algorithms may be embodied in one or more instructions that may be executed by a processing device. The instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processing device such the processing device can read information from, and write information to, the storage medium. In the alternative, the storage medium may be integral to the processing device. The processing device and the storage medium may reside in an ASIC. The ASIC may reside in a user terminal. In the alternative, the processing device and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of estimating a geolocation of one of a first wireless device or a second wireless device comprising:
receiving, at the first wireless device, a signal from the second wireless device;
determining, at the first wireless device, a physical characteristic of the received signal; and
determining, at the first wireless device, a region on a map representing a geolocation of the first wireless device or the second wireless device based on the physical characteristic of the received signal, a state transition matrix and a state occupancy vector.

2. The method of claim 1 wherein the map includes a set of predetermined regions where each region corresponds to a state.

3. The method of claim 2 wherein the state transition matrix includes state transition metrics that correspond to pairs of states and which are selected from a group consisting of a number, a value, a vector, a probability between 0 and 1, and combinations thereof.

4. The method of claim 2 wherein the state occupancy vector includes state occupancy metrics that correspond to states and which are selected from a group consisting of a number, a value, a vector, a probability between 0 and 1, and combinations thereof.

5. The method of claim 4 wherein each state occupancy metric corresponding to a state represents the probability that the first wireless device is located in the region represented by the state.

6. The method of claim 4 wherein each state occupancy metric corresponding to a state represents the probability that the second wireless device is located in the region represented by the state.

7. The method of claim 4 wherein determining a region on a map comprises selecting a state with the highest state occupancy metric.

8. The method of claim 2 wherein the state transition matrix is based on a mobility model.

9. The method of claim 8 wherein the mobility model is based on a probability distribution on a distance and a direction that the first wireless device can move in a time interval determined by a rate at which the second wireless device transmits the sequence of positioning signals.

10. The method of claim 9 wherein the rate is determined by the number of positioning signals transmitted by the second wireless device in one second.

11. The method of claim 10 wherein each region is defined by an area on the map and the area of each region in the set of regions is monotonically decreasing with the rate at which the second wireless device transmits the sequence of positioning signals.

12. The method of claim 8 wherein the mobility model is based on a probability distribution on a distance and a direction that the second wireless device can move in a time interval determined by a rate at which the second wireless device transmits the sequence of positioning signals.

13. The method of claim 12 wherein the rate is determined by the number of positioning signals transmitted by the second wireless device in one second.

14. The method of claim 13 wherein each region is defined by an area on the map and the area of each region in the set of regions is monotonically decreasing with the rate at which the second wireless device transmits the sequence of positioning signals.

15. The method of claim 1 wherein the physical characteristic of the received signal from the second wireless device is selected from a group consisting of received average power, received peak power, received average energy, received peak energy, tap delay, tap delay spread, and combinations thereof.

16. The method of claim 1 further comprising adjusting, at the first wireless device, the state occupancy vector based on the state transition matrix.

17. The method of claim 1 further comprising adjusting, at the first wireless device, the state occupancy vector based on a pre-determined function of the physical characteristic of the received signal.

18. The method of claim 17 wherein the pre-determined function is a probability density function.

19. The method of claim 17 wherein the pre-determined function is based on a physical characteristic prediction map which describes a predicted probability distribution, as a function of the geographic position of a receiver, of the physical characteristic of the received signal transmitted from the second wireless device.

20. The method of claim 19 wherein the physical characteristic prediction map is obtained at the first wireless device by downloading it from one of the second wireless device, a wireless network device, a wireless local area network access point, a wide area network base-station, a dedicated wireless positioning device or a wired network.

21. The method of claim 1 wherein the received signal is one of a sequence of positioning signals transmitted by the second wireless device.

22. The method of claim 1 wherein the state transition matrix is based on a set of physical constraints on the map.

23. The method of claim 22 wherein the set of physical constraints is selected from a group consisting of barriers, walls, buildings, ceilings, doors, floors, furniture, office objects, home objects, shopping mall objects, and combinations thereof.

24. The method of claim 22 wherein information about locations of the set of physical constraints is contained in the map.

25. The method of claim 1 wherein the received signal from the second wireless device is one of a peer-to-peer discovery signal, a peer-to-peer traffic signal, a peer-to-peer paging signal, a dedicated positioning signal or a beacon signal.

26. The method of claim 1 wherein the first wireless device is one of a mobile wireless communications device, a wireless network device, a wireless local area network access point, a wide area network base-station or a dedicated wireless positioning device.

27. The method of claim 1 wherein the second wireless device is one of a mobile wireless communications device, a wireless network device, a wireless local area network access point, a wide area network base-station or a dedicated wireless positioning device.

28. The method of claim 1 further comprising downloading the map, at the first wireless device, from one of a server, a mobile wireless communications device, a wireless network device, a wireless local area network access point, a wide area network base-station, a dedicated wireless positioning device or a wired network.

29. The method of claim 1 further comprising obtaining, at the first wireless device, information about the location of the second wireless device on the map.

30. The method of claim 29 wherein the information about the location of the second wireless device on the map is known to the first wireless device from information contained in the map.

31. The method of claim 30 wherein the information about the location of the second wireless device is received by the first wireless device from a signal transmitted by one of the second wireless device, a mobile wireless communications device, a wireless network device, a wireless local area network access point, a wide area network base-station, a dedicated wireless positioning device or a wired network.

32. The method of claim 1 further comprising obtaining, at the first wireless device, information about the location of the first wireless device on the map.

33. The method of claim 32 wherein the information about the location of the first wireless device on the map is known to the first wireless device from information contained in the map.

34. The method of claim 33 wherein the information about the location of the first wireless device is determined by the first wireless device based on a signal transmitted by one of a mobile wireless communications device, a wireless network device, a wireless local area network access point, a wide area network base-station, a dedicated wireless positioning device or a wired network.

35. A first wireless device for estimating a geolocation of a second wireless device comprising:
a processor configured to:
receive a signal from the second wireless device;
determine a physical characteristic of the received signal; and
determine a region on a map representing a geolocation of the second wireless device based on the physical characteristic of the received signal, a state transition matrix and a state occupancy vector.

36. The first wireless device of claim 35 wherein the map includes a set of predetermined regions where each region corresponds to a state.

37. The first wireless device of claim 36 wherein the state transition matrix includes state transition metrics that correspond to pairs of states and which are selected from a group consisting of a number, a value, a vector, a probability between 0 and 1, and combinations thereof.

38. The first wireless device of claim 36 wherein the state occupancy vector includes state occupancy metrics that correspond to states and which are selected from a group consisting of a number, a value, a vector, a probability between 0 and 1, and combinations thereof.

39. The first wireless device of claim 38 wherein each state occupancy metric corresponding to a state represents the probability that the first wireless device is located in the region represented by the state.

40. The first wireless device of claim 38 wherein each state occupancy metric corresponding to a state represents the probability that the second wireless device is located in the region represented by the state.

41. The first wireless device of claim 38 wherein to determine a region on a map further comprises the processor configured to select a state with the highest state occupancy metric.

42. The first wireless device of claim 36 wherein the state transition matrix is based on a mobility model.

43. The first wireless device of claim 42 wherein the mobility model is based on a probability distribution on a distance and a direction that the first wireless device can move in a time interval determined by a rate at which the second wireless device transmits the sequence of positioning signals.

44. The first wireless device of claim 43 wherein the rate is determined by the number of positioning signals transmitted by the second wireless device in one second.

45. The first wireless device of claim 44 wherein each region is defined by an area on the map and the area of each region in the set of regions is monotonically decreasing with the rate at which the second wireless device transmits the sequence of positioning signals.

46. The first wireless device of claim 42 wherein the mobility model is based on a probability distribution on a distance and a direction that the second wireless device can move in a time interval determined by a rate at which the second wireless device transmits the sequence of positioning signals.

47. The first wireless device of claim 46 wherein the rate is determined by the number of positioning signals transmitted by the second wireless device in one second.

48. The first wireless device of claim 47 wherein each region is defined by an area on the map and the area of each region in the set of regions is monotonically decreasing with the rate at which the second wireless device transmits the sequence of positioning signals.

49. The first wireless device of claim 35 wherein the physical characteristic of the received signal from the second wireless device is selected from a group consisting of received average power, received peak power, received average energy, received peak energy, tap delay, tap delay spread, and combinations thereof.

50. The first wireless device of claim 35 wherein the processor is further configured to adjust the state occupancy vector based on the state transition matrix.

51. The first wireless device of claim 35 wherein the processor is further configured to adjust the state occupancy vector based on a pre-determined function of the physical characteristic of the received signal.

52. The first wireless device of claim 51 wherein the pre-determined function is a probability density function.

53. The first wireless device of claim 51 wherein the pre-determined function is based on a physical characteristic prediction map which describes a predicted probability distribution, as a function of the geographic position of a receiver, of the physical characteristic of the received signal transmitted from the second wireless device.

54. The first wireless device of claim 53 wherein the physical characteristic prediction map is obtained at the first wireless device by downloading it from one of the second wireless device, a wireless network device, a wireless local area network access point, a wide area network base-station, a dedicated wireless positioning device or a wired network.

55. The first wireless device of claim 35 wherein the received signal is one of a sequence of positioning signals transmitted by the second wireless device.

56. The first wireless device of claim 35 wherein the state transition matrix is based on a set of physical constraints on the map.

57. The first wireless device of claim 56 wherein the set of physical constraints is selected from a group consisting of barriers, walls, buildings, ceilings, doors, floors, furniture, office objects, home objects, shopping mall objects, and combinations thereof.

58. The first wireless device of claim 56 wherein information about locations of the set of physical constraints is contained in the map.

59. The first wireless device of claim 35 wherein the received signal from the second wireless device is one of a peer-to-peer discovery signal, a peer-to-peer traffic signal, a peer-to-peer paging signal, a dedicated positioning signal or a beacon signal.

60. The first wireless device of claim 35 wherein the first wireless device is one of a mobile wireless communications device, a wireless network device, a wireless local area network access point, a wide area network base-station or a dedicated wireless positioning device.

61. The first wireless device of claim 35 wherein the second wireless device is one of a mobile wireless communications device, a wireless network device, a wireless local area network access point, a wide area network base-station or a dedicated wireless positioning device.

62. The first wireless device of claim 35 wherein the processor is further configured to download the map from one of a server, a mobile wireless communications device, a wireless network device, a wireless local area network access point, a wide area network base-station, a dedicated wireless positioning device or a wired network.

63. The first wireless device of claim 35 wherein the processor is further configured to obtain information about the location of the second wireless device on the map.

64. The first wireless device of claim 63 wherein the information about the location of the second wireless device on the map is known to the first wireless device from information contained in the map.

65. The first wireless device of claim 64 wherein the information about the location of the second wireless device is received by the first wireless device from a signal transmitted by one of the second wireless device, a mobile wireless communications device, a wireless network device, a wireless local area network access point, a wide area network base-station, a dedicated wireless positioning device or a wired network.

66. The first wireless device of claim 35 wherein the processor is further configured to obtain information about the location of the first wireless device on the map.

67. The first wireless device of claim 66 wherein the information about the location of the first wireless device on the map is known to the first wireless device from information contained in the map.

68. The first wireless device of claim 67 wherein the information about the location of the first wireless device is determined by the first wireless device based on a signal transmitted by one of a mobile wireless communications device, a wireless network device, a wireless local area network access point, a wide area network base-station, a dedicated wireless positioning device or a wired network.

69. A machine-readable medium comprising instructions for estimating a geolocation of one of a first wireless device or a second wireless device, the instructions upon execution cause a processor to:
receive, at the first wireless device, a signal from the second wireless device;
determine, at the first wireless device, a physical characteristic of the received signal; and
determine, at the first wireless device, a region on a map representing a geolocation of the first wireless device or the second wireless device based on the physical characteristic of the received signal, a state transition matrix and a state occupancy vector.

70. The machine-readable medium of claim 69 wherein the map includes a set of predetermined regions where each region corresponds to a state.

71. The machine-readable medium of claim 70 wherein the state transition matrix includes state transition metrics that correspond to pairs of states and which are selected from a group consisting of a number, a value, a vector, a probability between 0 and 1, and combinations thereof.

72. The machine-readable medium of claim 70 wherein the state occupancy vector includes state occupancy metrics that correspond to states and which are selected from a group consisting of a number, a value, a vector, a probability between 0 and 1, and combinations thereof.

73. The machine-readable medium of claim 72 wherein each state occupancy metric corresponding to a state represents the probability that the first wireless device is located in the region represented by the state.

74. The machine-readable medium of claim 72 wherein each state occupancy metric corresponding to a state represents the probability that the second wireless device is located in the region represented by the state.

75. The machine-readable medium of claim 72 wherein the instructions to determine a region on a map comprises instructions to select a state with the highest state occupancy metric.

76. The machine-readable medium of claim 70 wherein the state transition matrix is based on a mobility model.

77. The machine-readable medium of claim 76 wherein the mobility model is based on a probability distribution on a distance and a direction that the first wireless device can move in a time interval determined by a rate at which the second wireless device transmits the sequence of positioning signals.

78. The machine-readable medium of claim 77 wherein the rate is determined by the number of positioning signals transmitted by the second wireless device in one second.

79. The machine-readable medium of claim 78 wherein each region is defined by an area on the map and the area of each region in the set of regions is monotonically decreasing with the rate at which the second wireless device transmits the sequence of positioning signals.

80. The machine-readable medium of claim 76 wherein the mobility model is based on a probability distribution on a distance and a direction that the second wireless device can move in a time interval determined by a rate at which the second wireless device transmits the sequence of positioning signals.

81. The machine-readable medium of claim 80 wherein the rate is determined by the number of positioning signals transmitted by the second wireless device in one second.

82. The machine-readable medium of claim 81 wherein each region is defined by an area on the map and the area of each region in the set of regions is monotonically decreasing with the rate at which the second wireless device transmits the sequence of positioning signals.

83. The machine-readable medium of claim 69 wherein the physical characteristic of the received signal from the second wireless device is selected from a group consisting of received average power, received peak power, received average energy, received peak energy, tap delay, tap delay spread, and combinations thereof.

84. The machine-readable medium of claim 69 further comprising instructions to adjust, at the first wireless device, the state occupancy vector based on the state transition matrix.

85. The machine-readable medium of claim 69 further comprising instructions to adjust, at the first wireless device, the state occupancy vector based on a pre-determined function of the physical characteristic of the received signal.

86. The machine-readable medium of claim 85 wherein the pre-determined function is a probability density function.

87. The machine-readable medium of claim 85 wherein the pre-determined function is based on a physical characteristic prediction map which describes a predicted probability distribution, as a function of the geographic position of a receiver, of the physical characteristic of the received signal transmitted from the second wireless device.

88. The machine-readable medium of claim 87 wherein the physical characteristic prediction map is obtained at the first wireless device by downloading it from one of the second wireless device, a wireless network device, a wireless local area network access point, a wide area network base-station, a dedicated wireless positioning device or a wired network.

89. The machine-readable medium of claim 69 wherein the received signal is one of a sequence of positioning signals transmitted by the second wireless device.

90. The machine-readable medium of claim 69 wherein the state transition matrix is based on a set of physical constraints on the map.

91. The machine-readable medium of claim 90 wherein the set of physical constraints is selected from a group consisting of barriers, walls, buildings, ceilings, doors, floors, furniture, office objects, home objects, shopping mall objects, and combinations thereof.

92. The machine-readable medium of claim 90 wherein information about locations of the set of physical constraints is contained in the map.

93. The machine-readable medium of claim 69 wherein the received signal from the second wireless device is one of a peer-to-peer discovery signal, a peer-to-peer traffic signal, a peer-to-peer paging signal, a dedicated positioning signal or a beacon signal.

94. The machine-readable medium of claim 69 wherein the first wireless device is one of a mobile wireless communications device, a wireless network device, a wireless local area network access point, a wide area network base-station or a dedicated wireless positioning device.

95. The machine-readable medium of claim 69 wherein the second wireless device is one of a mobile wireless communications device, a wireless network device, a wireless local area network access point, a wide area network base-station or a dedicated wireless positioning device.

96. The machine-readable medium of claim 69 further comprising downloading the map, at the first wireless device, from one of a server, a mobile wireless communications device, a wireless network device, a wireless local area network access point, a wide area network base-station, a dedicated wireless positioning device or a wired network.

97. The machine-readable medium of claim 69 further comprising obtaining, at the first wireless device, information about the location of the second wireless device on the map.

98. The machine-readable medium of claim 97 wherein the information about the location of the second wireless device on the map is known to the first wireless device from information contained in the map.

99. The machine-readable medium of claim 98 wherein the information about the location of the second wireless device is received by the first wireless device from a signal transmitted by one of the second wireless device, a mobile wireless communications device, a wireless network device, a wireless local area network access point, a wide area network base-station, a dedicated wireless positioning device or a wired network.

100. The machine-readable medium of claim 69 further comprising instructions to obtain, at the first wireless device, information about the location of the first wireless device on the map.

101. The machine-readable medium of claim 100 wherein the information about the location of the first wireless device on the map is known to the first wireless device from information contained in the map.

102. The machine-readable medium of claim 101 wherein the information about the location of the first wireless device is determined by the first wireless device based on a signal transmitted by one of a mobile wireless communications device, a wireless network device, a wireless local area network access point, a wide area network base-station, a dedicated wireless positioning device or a wired network.

103. An apparatus for estimating a geolocation of one of a first wireless device or a second wireless device comprising:
means for receiving, at the first wireless device, a signal from the second wireless device;
means for determining, at the first wireless device, a physical characteristic of the received signal; and
means for determining, at the first wireless device, a region on a map representing a geolocation of the first wireless device or the second wireless device based on the physical characteristic of the received signal, a state transition matrix and a state occupancy vector.

104. The apparatus of claim 103 wherein the map includes a set of predetermined regions where each region corresponds to a state.

105. The apparatus of claim 104 wherein the state transition matrix includes state transition metrics that correspond to pairs of states and which are selected from a group consisting of a number, a value, a vector, a probability between 0 and 1, and combinations thereof.

106. The apparatus of claim 104 wherein the state occupancy vector includes state occupancy metrics that correspond to states and which are selected from a group consisting of a number, a value, a vector, a probability between 0 and 1, and combinations thereof.

107. The apparatus of claim 106 wherein each state occupancy metric corresponding to a state represents the probability that the first wireless device is located in the region represented by the state.

108. The apparatus of claim 106 wherein each state occupancy metric corresponding to a state represents the probability that the second wireless device is located in the region represented by the state.

109. The apparatus of claim 106 wherein determining a region on a map comprises selecting a state with the highest state occupancy metric.

110. The apparatus of claim 104 wherein the state transition matrix is based on a mobility model.

111. The apparatus of claim 110 wherein the mobility model is based on a probability distribution on a distance and a direction that the first wireless device can move in a time interval determined by a rate at which the second wireless device transmits the sequence of positioning signals.

112. The apparatus of claim 111 wherein the rate is determined by the number of positioning signals transmitted by the second wireless device in one second.

113. The apparatus of claim 112 wherein each region is defined by an area on the map and the area of each region in the set of regions is monotonically decreasing with the rate at which the second wireless device transmits the sequence of positioning signals.

114. The apparatus of claim 110 wherein the mobility model is based on a probability distribution on a distance and a direction that the second wireless device can move in a time interval determined by a rate at which the second wireless device transmits the sequence of positioning signals.

115. The apparatus of claim 114 wherein the rate is determined by the number of positioning signals transmitted by the second wireless device in one second.

116. The apparatus of claim 115 wherein each region is defined by an area on the map and the area of each region in the set of regions is monotonically decreasing with the rate at which the second wireless device transmits the sequence of positioning signals.

117. The apparatus of claim 103 wherein the physical characteristic of the received signal from the second wireless device is selected from a group consisting of received average power, received peak power, received average energy, received peak energy, tap delay, tap delay spread, and combinations thereof.

118. The apparatus of claim 103 further comprising means for adjusting, at the first wireless device, the state occupancy vector based on the state transition matrix.

119. The apparatus of claim 103 further comprising means for adjusting, at the first wireless device, the state occupancy vector based on a pre-determined function of the physical characteristic of the received signal.

120. The apparatus of claim 119 wherein the pre-determined function is a probability density function.

121. The apparatus of claim 119 wherein the pre-determined function is based on a physical characteristic prediction map which describes a predicted probability distribution, as a function of the geographic position of a receiver, of the physical characteristic of the received signal transmitted from the second wireless device.

122. The apparatus of claim 121 wherein the physical characteristic prediction map is obtained at the first wireless device by downloading it from one of the second wireless device, a wireless network device, a wireless local area network access point, a wide area network base-station, a dedicated wireless positioning device or a wired network.

123. The apparatus of claim 103 wherein the received signal is one of a sequence of positioning signals transmitted by the second wireless device.

124. The apparatus of claim 103 wherein the state transition matrix is based on a set of physical constraints on the map.

125. The apparatus of claim 124 wherein the set of physical constraints is selected from a group consisting of barriers, walls, buildings, ceilings, doors, floors, furniture, office objects, home objects, shopping mall objects, and combinations thereof.

126. The apparatus of claim 124 wherein information about locations of the set of physical constraints is contained in the map.

127. The apparatus of claim 103 wherein the received signal from the second wireless device is one of a peer-to-peer discovery signal, a peer-to-peer traffic signal, a peer-to-peer paging signal, a dedicated positioning signal or a beacon signal.

128. The apparatus of claim 103 wherein the first wireless device is one of a mobile wireless communications device, a wireless network device, a wireless local area network access point, a wide area network base-station or a dedicated wireless positioning device.

129. The apparatus of claim 103 wherein the second wireless device is one of a mobile wireless communications device, a wireless network device, a wireless local area network access point, a wide area network base-station or a dedicated wireless positioning device.

130. The apparatus of claim 103 further comprising means for downloading the map, at the first wireless device, from one of a server, a mobile wireless communications device, a wireless network device, a wireless local area network access point, a wide area network base-station, a dedicated wireless positioning device or a wired network.

131. The apparatus of claim 103 further comprising means for obtaining, at the first wireless device, information about the location of the second wireless device on the map.

132. The apparatus of claim 131 wherein the information about the location of the second wireless device on the map is known to the first wireless device from information contained in the map.

133. The apparatus of claim 132 wherein the information about the location of the second wireless device is received by the first wireless device from a signal transmitted by one of the second wireless device, a mobile wireless communications device, a wireless network device, a wireless local area network access point, a wide area network base-station, a dedicated wireless positioning device or a wired network.

134. The apparatus of claim 103 further comprising means for obtaining, at the first wireless device, information about the location of the first wireless device on the map.

135. The apparatus of claim 134 wherein the information about the location of the first wireless device on the map is known to the first wireless device from information contained in the map.

136. The apparatus of claim 135 wherein the information about the location of the first wireless device is determined by the first wireless device based on a signal transmitted by one of a mobile wireless communications device, a wireless network device, a wireless local area network access point, a wide area network base-station, a dedicated wireless positioning device or a wired network.
